(19) United States
(12) Patent Application Publication
(10) Pub. No.: US 2007/0144359 A1
(43) Pub. Date: Jun. 28, 2007

(54) APPARATUS, SYSTEM, AND METHOD FOR MAKING SANDWICHES

(76) Inventors: Lane Ekberg, West Jordan, UT (US); Paul M. Perrine, Rising Sun, IN (US); Darren Schmitt, Salt Lake City, UT (US)

Correspondence Address: Kunzler & McKenzie, 8 EAST BROADWAY, SUITE 600, SALT LAKE CITY, UT, 84111, US

(21) Appl. No.: 11/615,725

(22) Filed: Dec. 22, 2006

Related U.S. Application Data
(60) Provisional application No. 60/753,595, filed on Dec. 22, 2005.

(51) Int. Cl. A21C 9/04

(52) U.S. Cl. 99/450.4

(57) ABSTRACT

An apparatus, system, and method are disclosed for making sandwiches. A bladeless sandwich making apparatus is provided with lower and upper tools having sandwich receiving cavities configured to accommodate sandwich ingredients and a mechanism for mounting configured to operate as a hinge and as a handle. Bread layers and filling may be placed within the apparatus in an open position. A filling material cup may be used for filling preparation. Beneficially, the apparatus may include an impression bar or plate to imprint design on an outer sandwich surface or for sandwich separation. The upper tool is configured to engage the lower tool to remove sandwich crusts and seal sandwich edges. The crustless sandwich with sealed edges may be consumed, stored, or heated. A method is disclosed for making sandwiches without crusts and sealed edges with or without designs on the sandwich surface.

### CROSS-REFERENCES TO RELATED APPLICATIONS

This application is a continuation-in-part of and claims priority to U.S. Provisional Patent Application No. 60/753,595 entitled “Apparatus and Method for Making Sandwiches” and filed on Dec. 22, 2005 for Paul M Perrine, which is incorporated herein by reference.

### BACKGROUND OF THE INVENTION

1. Field of the Invention

This invention relates to the field of devices for making sandwiches and more particularly relates to devices that bring together the edges of the bread and seal them while cutting off the crusts of bread.

2. Description of the Related Art

Sandwich making devices are well known in the art. Many of these devices and methods of use provide a user with sandwiches having one or more inner filling layers and outer bread layers having sealed edges such that the filling layers are trapped in a bread pocket or cavity. Sandwiches of this nature are beneficial for storing, freezing, transporting and heating at a time later than making the sandwich. Many users prefer to have the crusts from the bread of the sandwich removed from the sandwich before consuming.

It is cumbersome to remove the crusts of sandwich bread using a standard knife. Using a knife typically requires a user to use four cutting actions to remove crusts from a standard rectangular sandwich. Devices that are known to remove crusts from the bread of sandwiches in one cutting operation exist; however, they either require knife or sharp cutting blade elements to be present on the apparatus, or they do not provide adequate sandwich sealing functions.

Some sandwich making devices are used to make crustless sandwiches with sealed edges for ease of transport and storage of sandwiches. Devices known in the art that produce these sandwiches will cut crusts off the sandwiches either prior to sealing or during the sealing operation with sharp blades or knives integrated in the apparatus. A blade is an additional sharp cutting element made of metal, glass, ceramics, plastic or the like that has been added to the devices.

For example, sandwich sealing presses exist in which an upper press face is aligned with a lower press face. Pressing of the faces together seals the bread slices. Outer blades, on this device, cut crusts off during the pressing operation. Additional sandwich sealing devices have been offered that cut the crusts off sandwiches without using blades; however, the hinge mechanism used on these devices requires the cut sandwich to be significantly smaller in size then the bread slices would allow and have problems with smashing or tearing the sandwiches.

While these cutting elements mentioned above may be appropriate in some commercial settings, for home use, and especially for use by children, there is a need in the art to have a bladeless apparatus for cutting and removing crusts from sandwiches while simultaneously sealing the sandwich edges. A blade is an additional sharp cutting element made of metal, glass, ceramics, plastic or the like that has been added to the apparatus for the purpose of slicing through material

Additionally, there exists in the art devices that will seal the edges of sandwiches using heat. These sandwich grills have two heated halves that allow a user to heat-seal edges of sandwiches during a sandwich grilling process. These devices also may grill designs in an outer surface of a sandwich. These devices, however, produce sandwiches for immediate consumption. Also, the crusts remain on the bread and finished sandwiches, and the devices are not beneficial for making sandwiches that can be stored, transported, or re-cooked at later times.

Therefore, a need exists for a sandwich making apparatus, system and method that overcomes the disadvantages of the prior art. From the foregoing discussion, it should be apparent that a need exists for an apparatus that allows a user to safely and easily make a crustless sandwich with sealed edges at ambient temperatures and without the use of sharp elements. Additionally, it would be advantageous to have a device that is small, lightweight, inexpensive, and easy to use at home or during traveling. Furthermore, it would be beneficial to add designs to an outer bread surface without the use of heat such that the design would be present on a sandwich at ambient temperatures as well as maintained during transport, storage, and subsequent heating of the sandwich.

### SUMMARY OF THE INVENTION

The present invention has been developed in response to the present state of the art, and in particular, in response to the problems and needs in the art that have not yet been fully solved by currently available sandwich makers. Accordingly, the present invention has been developed to provide an apparatus, system, and method for making sandwiches with sealed edges while cutting off the crusts of the bread without using knives or blades. The sealed edges of the sandwich form a center bread pocket that prevents sandwich filling material from escaping the sandwich. Additionally, the present invention may be made using lightweight material, such as plastic, and requires little strength to apply sufficient pressure to seal bread edges. These advantages overcome many or all of the above-discussed shortcomings in the art.

For the sake of avoiding repetition, the term “sandwich” will be used herein to include a food product comprising two or more layers of bread which are brought together with an edible filling material between the layers. The layers may take the form of separate slices of bread cut from a conventional loaf of bread, or a single slice of bread folded over on itself. The layers, however, may take any suitable form. For example, the bread layers may be formed from pieces of bread dough which are made into a desired shape before they are baked so that, after baking, they do not need to be cut or further shaped before being used to make the sandwich. One such shape may be that of a conventional rectangular slice of bread.

Furthermore, the term “bread” is used in abroad sense herein to imply that the product is pre-baked or otherwise cooked before it is used for making sandwiches with the apparatus, system, and method of this present invention. It is intended to include any suitable bread-like product which incorporates baked dough as an essential ingredient and acts as layers to hold sandwich filling material. This may include conventional sandwich bread, tortillas, biscuits, pastry and the like.

A bladeless sandwich making apparatus is provided with an upper tool and a lower tool each having raised shoulders incorporated on perimeter edges of the upper and lower tools. The upper and lower tools are cupped within the raised shoulders providing sandwich receiving cavities to accept a sandwich half therein. The upper and lower tools may be configured so that the upper shoulder of the upper tool closely surrounds the lower shoulder of the lower tool to receive the lower shoulder therein. It is apparent that in another embodiment, the upper and lower tools may be configured so that the lower shoulder closely surrounds the upper shoulder to receive the upper shoulder therein.

The raised edges of the upper and lower shoulders are positioned such that the upper or lower shoulder may pass by the shoulder of the opposing tool. When bread slices overlap the perimeter edges of the upper and lower tools, the bread will be cut at the junction between the upper shoulder and the lower shoulder effectively removing the crusts of the bread. The clearance between the upper shoulder and the lower shoulder, when engaged, operates beneficially at less then twenty-eight thousandths of an inch, and would preferably be between approximately ten- and twenty-thousandths of an inch. This range of clearance enables a complete cut of the crusts from the bread. The addition of blades or sharp edges on the upper and lower tools is not necessary as the overlapping configuration of the upper and lower shoulders is sufficient to cut the crusts of the bread slices. Advantageously, the present sandwich maker is safe for a user, including a child, to operate.

The upper shoulder is further provided with a crimping face that confronts and cooperates with a lower shoulder face of the lower shoulder to press the cut outer edges of the bread slices together to form a sealed edge, and thereby, creating a central sandwich pocket containing sandwich filling material. The sealed edge is produced intermediate the height of the sandwich preventing one bread layer to be more extended then the opposite bread layer. In another embodiment, the crimping face of the upper shoulder may include graduated steps of differing vertical height and confront the lower shoulder face of the opposing lower tool to compress and seal the outer edges of the bread slices such that the outer-most edge of the bread seal is more compressed than the bread seal along the inner-most edge of the seal. In a further embodiment, graduated steps can be provided on both the crimping face and the confronting lower shoulder face.

In one embodiment, the sandwich maker is provided with a pivotal connection and handles. The upper and lower tools are hinged together through a pivotal connection, to easily align and apply pressure equally on all perimeter edges of the upper and lower tools. A pivotal connection may be any mechanical device, such as a mechanical hinge, that connects the upper and lower tools, allowing rotation between them. In another embodiment, the pivotal connection may be a living hinge. As used herein, “living hinge” means a hinge that includes no moving parts, such as thin section of the material that bends to allow movement. In a further embodiment, the pivotal connection may comprise a flexible planar adhesive. In yet a further embodiment, the pivotal connection comprises a corresponding pair of hook and loop strips such as Velcro® strips.

In one embodiment, the apparatus further includes an upper arm extending from the upper tool operating as a handle and a lower arm extending from the lower tool operating as a handle. The upper arm may move relative to the lower arm around the pivotal connection. In one embodiment, the pivotal connection may be on an opposed side to the upper and lower arms, and may be placed close to the upper and lower tools. In certain embodiments, the pivotal connection is placed on the upper and lower arms at varying distances from the upper and lower tools. In one embodiment, the upper and lower arms have lengths between the upper and lower tools and the pivotal connection that are greater than 1.5 inches to allow the upper tool to engage the lower tool at a substantially vertical position. In other embodiments, the lengths between the upper and lower tools and the pivotal connection may be between 2 inches and 6 inches, such as 3.5 inches. In some embodiments, the lengths between the upper and lower tools and the pivotal connection may be one-half inch.

The upper and lower arms may have notches adjacent to attachments to the upper and lower tools. The notches provide space for the cut crusts to fall away from the upper and lower shoulders and allow the upper tool to meet and crimp against the confronting lower tool to form the sealed edge of the sandwich.

In one position, the bladeless sandwich making apparatus is configured to be in an essentially closed position such that the crimping face of the upper tool is engaged fully with the lower shoulder face of the lower shoulders. In this position, the upper and lower arms may be held together as a handle for the bladeless sandwich making apparatus. The upper arm may be squeezed against the lower arm to apply pressure between the upper and lower tools for cutting crusts and sealing the sandwich edge.

In an open position, the upper tool is disengaged from the lower tool to expose the upper and lower sandwich receiving cavities. In one embodiment, the upper tool may pivot around a pivot point to separate the upper tool from the lower tool and to expose the upper and lower sandwich receiving cavities. In a further embodiment, the pivot point acts a hinge between the upper and lower arms and the hinge is place at a distance greater than 1.5 inches from the upper and lower tools. In another embodiment, the distance between the hinge connecting the upper and lower arms and the upper and lower tools is greater than one-half inch. In yet a further embodiment, the distance between the hinge connecting the upper and lower arms and the upper and lower tools is between 2 inches and 6 inches. The hinge connecting the upper and lower arms is placed, in yet another embodiment, at a distance of 3.5 inches from the upper and lower tools such that the upper tool may initially pivot away from the lower tool in a substantially vertical trajectory. The lower tool may include a gripping tab or handle extending from the lower front thereof to be held by a thumb or finger of one hand of a user. The gripping tab facilitates the user in transitioning the bladeless sandwich making apparatus from the essentially closed position to the open position. The second hand of the user may separate the upper tool from the lower tool by gripping and lifting up on the shoulder of the upper tool. This allows easy opening of the bladeless sandwich making apparatus for either starting a sandwich or for removal of a sealed sandwich.

In some embodiments, one or more impression bars may be removeably inserted into the sandwich receiving cavities of both the upper and lower tools to section the sandwich. In one embodiment, impression bars may be placed diagonally through each of the sandwich receiving cavities of the upper and lower tools to create an indentation diagonally across the sandwich. If the impression bars are placed so that upper and lower impression bars meet when the upper and lower tools are brought together, the impression bars will seal the sandwich along the diagonal line so it may be easily broken into two halves. In a further embodiment, two impression bars may be used to extend from opposite corners in each of the sandwich receiving cavities in an “X” configuration to form a sandwich which can be easily broken into quarters. The use of two diagonal bars in each sandwich receiving cavity easily creates sealed quarter party sandwiches commonly used for hors d'oeuvres. It will be appreciated by one of ordinary skill in the art that any number of impression bars can be used in one or both upper and lower sandwich receiving cavities as desired.

In another embodiment, various arrangements of impression bars can be preassembled or molded in units. The impression bar arrangements are easy to insert and remove such that one arrangement of bars can be removed from the bladeless sandwich making apparatus and replaced with another preassembled unit of arranged impression bars.

The bladeless sandwich making apparatus may further comprise an impression design plate having a textured marking feature, such as a decorative design, picture, symbol, words, or the like, that may be used to create designs on a surface of the sandwich upon compression of the plate against the surface of the sandwich. The impression design plate may be removed and/or replaced with a second design plate, if desired.

The apparatus of the present invention also may provide a filling material cup. The filling material cup is provided with a width and a length that is smaller than a width and a length of the lower sandwich receiving cavity. The filling material cup also has a volume capacity to hold filling material such that the filling material may be transferred from the filling material cup to the lower bread slice for filling the center bread pocket of the sealed sandwich. The filling material cup may be used to prepare fillings for making sandwiches and specifically may be used for measuring, shaping, cutting and cooking filling material. The filling material cup, in one embodiment, is made of a microwaveable material, such as plastic, to be used in heating or cooking filling material in the microwave. An example of a filling material that can be cooked in a microwave and be used to fill a sandwich is an egg. In another embodiment, the filling material cup may be made of a metal, ceramic, glass, or a special high temperature plastic which can be placed either on a burner or in a conventional oven for heating or cooking a filling material. In a further embodiment, the filling material cup may be inverted on a cutting surface and used to cut sandwich filling material such as meat, cheese, and the like by pressing down. The filling material cup, in this embodiment, may be used to shape the filling material slices such that the filling material is in the desired shape and proportion for filling the sealed sandwich.

The present invention also provides a system for making sandwiches. The system includes, but is not limited to, a bladeless sandwich making apparatus including a lower tool with a raised lower shoulder and an outer edge, an upper tool with a raised upper shoulder and an inner edge, a clearance between the inner edge of the upper tool and the outer edge of the lower tool that is less than approximately twenty-eight thousandths of an inch, and a mechanism for mounting the lower tool and the upper tool. The mechanism for mounting is configured to permit the upper tool to move relative to the lower tool such that the apparatus may be in an open position or in a closed position. In one embodiment, the mechanism for mounting further comprises upper and lower arms that pivotally connect the upper and lower tools. The upper and lower arms operate as both a hinge for the upper and lower tools as well as a handle for a user to engage the hinge and apply pressure to seal the sandwich bread layers.

The system further includes a filling material cup, an impression design plate configured to imprint design images on the surface of the sealed sandwich, bottom and top bread layers, and sandwich filling material. In one embodiment, one slice of bread may fold over to form the bottom and top layers prior to sealing the bread edges. In another embodiment, the system includes a second slice of bread.

A method of the present invention is also presented for making sandwiches. The method in the disclosed embodiments substantially includes the steps necessary to carry out the functions presented above with respect to the operation of the described apparatus and system. In one embodiment, the method includes placing a lower bread layer on a lower tool of a bladeless sandwich making apparatus configured in an open position followed by placing filling material on the lower bread layer such that the filling material is substantially in the center of the lower bread layer and aligned with a lower sandwich receiving cavity. Subsequently, an upper bread layer is placed on the filling material such that it aligns with the lower bread layer. Next, an upper tool of the bladeless sandwich making apparatus pivotally engages the lower tool as an upper arm connected to an upper tool rotates around a pivotal connection with respect to a lower arm connected to a lower tool. Next, the method includes compressing the upper tool relative to the lower tool by squeezing the upper and lower arms together such that the upper tool passes through the upper and lower bread slices to operatively cut crusts from the bread slices. Also in this step, a cut edge of the upper bread slice is sealed together with a cut edge of the lower bread slice to form a crustless sandwich with a sealed edge. A user continues the method to pivotally disengage the upper tool from the lower tool followed by removing the crustless sandwich with a sealed edge from the sandwich making apparatus.

The method also may include preparing filling material using a filling material cup. Preparation of filling material may include measuring, shaping, cutting, and cooking filling material using the filling material cup. In other embodiments, the method includes storing or heating the crustless sandwich with a sealed edge following removal from the sandwich making apparatus. The method may also include adding a mirror marking feature on an outer sandwich surface prior to disengaging the upper tool from the lower tool.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating an embodiment of a bladeless sandwich making apparatus in an open position;

FIG. 2 is a cross-section side view illustrating a crustless sandwich with a sealed peripheral edge;

FIG. 3A is a cross-sectional side view of the bladeless sandwich making apparatus from FIG. 1 illustrating a closed position;

FIG. 3B is a cross-sectional side view of another embodiment of a crimping face of the bladeless sandwich making apparatus from FIG. 1;

FIG. 4 is a side view of another embodiment of the apparatus in accordance with the present invention illustrating the movement from an open to a closed position;

FIG. 5 is a cross-section of a front view the apparatus from FIG. 4 in a partially open position;

FIG. 6 is a cross-sectional side view the apparatus from FIG. 4 in a closed position;

FIG. 7 is a top plan view of the lower tool of the apparatus from FIG. 4 illustrating a lower impression bar in a diagonal orientation;

FIG. 8 is a bottom plan view of the upper tool of the apparatus from FIG. 4 illustrating an upper impression bar in a diagonal orientation;

FIG. 9 is a cross-section side view illustrating a crustless sandwich with a sealed peripheral edge and having indentations;

FIG. 10 is a perspective view illustrating a further embodiment of a bladeless sandwich making apparatus for use with an impression bar assembly;

FIG. 11 illustrates the use of an impression design plate with the apparatus from FIG. 1;

FIG. 12 is a front view illustrating two sandwich making apparatuses connected together;

FIG. 13 is a perspective view of a filling material cup provided in a further embodiment of the apparatus in accordance with the present invention;

FIG. 14 is a top and a side view of an inverted filling material cup configured to shape and cut filling material slices;

FIG. 15 is a perspective view illustrating one embodiment of the system in accordance with the present invention; and

FIG. 16 is a schematic flow chart diagram illustrating one embodiment of a method for making sandwiches in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Those of skill in the art will recognize that suitable materials are not limited to those described. It will be appreciated by those skilled in the art that the manufacturing material, sandwich ingredient material, and many other factors will cause the actual dimensions of the bladeless sandwich making apparatus to vary. In addition, the dimensions listed herein are provided only to clearly illustrate the invention and should not be construed as limiting the invention in any way.

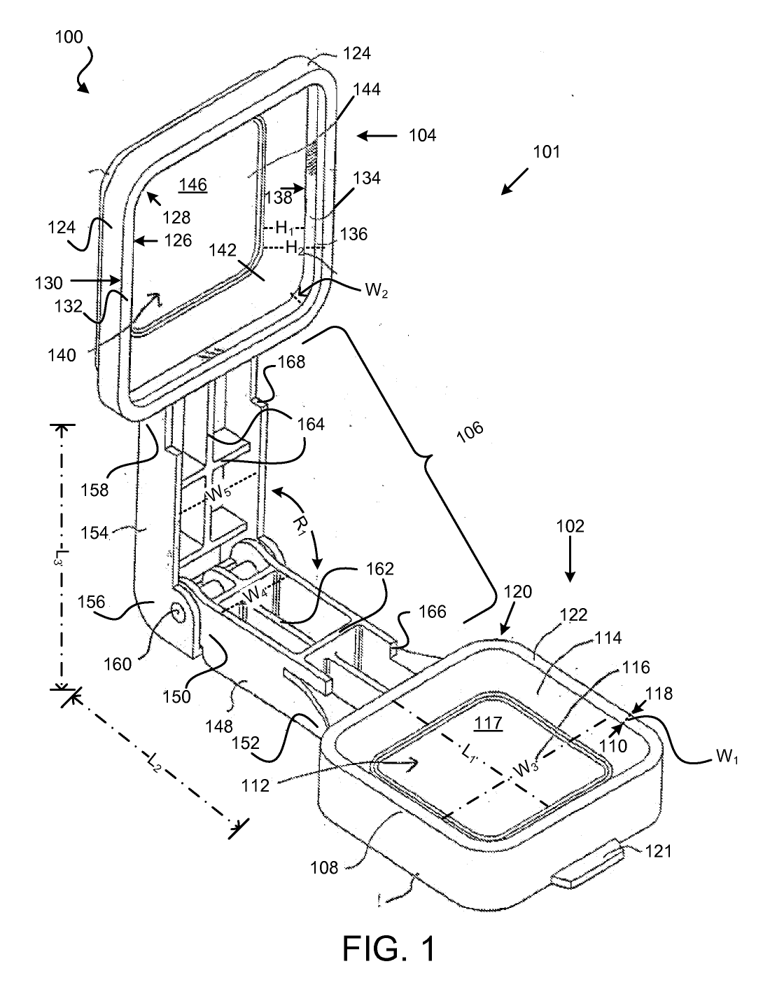

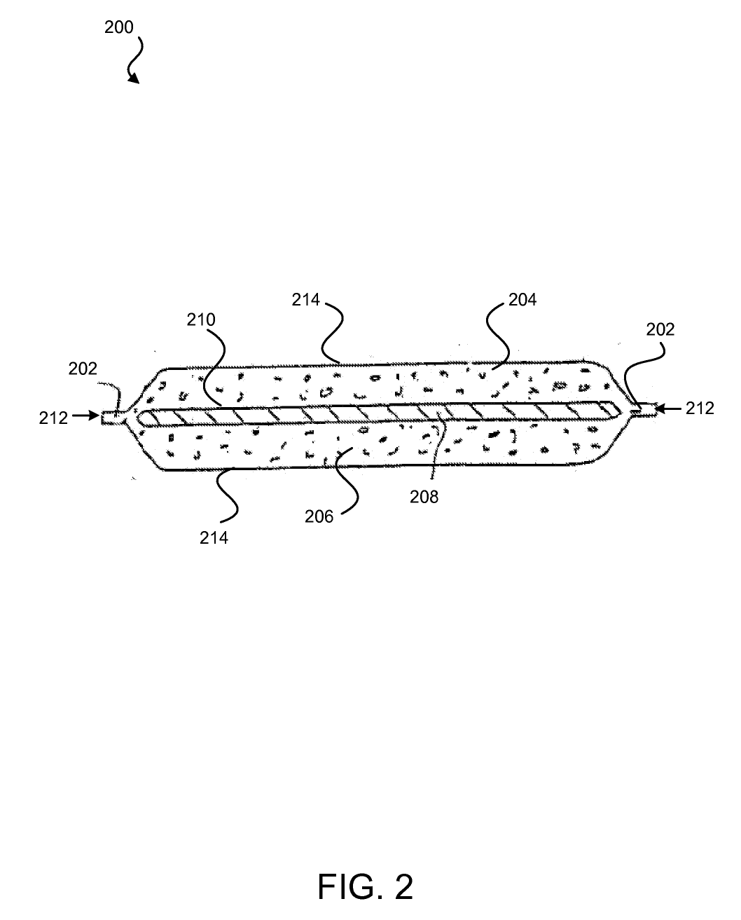

FIG. 1 depicts a bladeless sandwich making apparatus 100 in an open position 101 and FIG. 2 illustrates a crustless sandwich 200 with a sealed or crimped edge 202 produced by the bladeless sandwich making apparatus 100. The crustless sandwich 200 is made from a top bread layer 204 and a bottom bread layer 206 and includes an edible filling material 208 disposed between the top and bottom bread layers 204, 206. Generally, the bread layers 204, 206 will initially be in the form of slices (not shown) of bread cut from a conventional loaf of bread (not shown) and will have a crust section (not shown) around the slice periphery. The apparatus 100 advantageously removes the crust section by cutting the peripheral edges 212 of the bread layers 204, 206 and additionally forms the sealed edge 202.

It has been found that, when the edges (not shown) of two bread layers 204, 206 are squeezed or compressed together between tools which are properly designed and with sufficient pressure, a bond or seal 202 is formed between the two bread layers 204, 206 at their interfacing edge sections (not shown). This squeezing, or crimping, seals the two bread layers 204,206 together and forms a substantially sealed pocket 210 or cavity between the bread layers 204, 206 inwardly of the sealed edge 202 which can hold filling material 208.

The bladeless sandwich making apparatus 100 of FIG. 1 comprises a lower tool 102, an upper tool 104, and a mechanism for mounting 106 the lower tool 102 and upper tool 104 such that the upper tool 104 is permitted to move relative to the lower tool 102. The bladeless sandwich making apparatus 100 may be molded from a plastic material; however, a variety of additional materials, such as metal, glass, ceramic material and the like, may be used to form the whole apparatus 100 or each individual tool 102, 104 and mechanism for mounting 106. In a preferred embodiment, the material used for manufacturing the apparatus 100 would be inexpensive, lightweight, and resistant to heat.

The lower tool 102 of the bladeless sandwich making apparatus 100 comprises a raised lower shoulder 108. The lower shoulder 108 is further provided with an inner edge 110, defining a lower sandwich receiving cavity 112. The lower sandwich receiving cavity 112 is configured to accept half of a sandwich (not shown) and is provided with side walls 114 and a base 116 having a flat, rectangular inner base face 117. The lower shoulder 108 is also provided with an outer edge 118 defining a lower tool perimeter 120. Ideally, the lower tool perimeter 120 is smaller than a bread slice perimeter (not shown). The lower shoulder 108 is further provided with a lower shoulder face 122. The lower shoulder face 122 has a width W₁ that, in one embodiment, is one-eighth inch. It is appreciated by one of ordinary skill in the art that the width W₁ may be greater or smaller than one-eighth inch. The lower tool may also include a gripping tab 121 extending from the raised lower shoulder 108 on an outer surface 123.

The upper tool 104 of the bladeless sandwich making apparatus 100 comprises a raised upper shoulder 124. The upper shoulder 124 has an inner edge 126 defining an upper tool perimeter 128 that is greater than the lower tool perimeter 120. The upper shoulder 124 also includes an outer edge 130 and an upper shoulder face 132. Adjacent to the inner edge 126 of the upper shoulder 124, the upper tool 104 has disposed a crimping face 134. In one embodiment, the crimping face 134 has a crimping width W₂ that is essentially equal to the lower shoulder face width W₁. In another embodiment, the width W₂ is one-sixteenth inch. In a further embodiment, the width W₂ is between one-eighth inch and one-sixteenth inch. The crimping face 134 is also provided with a crimping perimeter 136 and an inner crimping edge 138 which defines an upper sandwich receiving cavity 140 configured to accommodate half of a sandwich (not shown). The upper sandwich receiving cavity 140 is provided with side walls 142 and a base 144 having a flat, rectangular inner base face 146. The crimping face 134 has a height H₁ that is shorter than a height H₂ of the upper shoulder face 132 with respect to the base facel46.

The shape of the sandwich 200 is determined by the shape of the upper and lower shoulders 108, 124 and the shape and profile of the upper and lower sandwich receiving cavities 112, 140. In the present embodiment, for use with commercially available bread in the United States, the upper and lower sandwich receiving cavities 112, 140 may be substantially rectangular so as to accommodate the shape of most commercially available bread and to reduce waste of bread. In one embodiment, the upper and lower sandwich receiving cavities 112, 140 have a length L₁ and a width W₃ each essentially equal to 3 inches. In other embodiments, the upper and lower sandwich receiving cavities 112, 140 may have other shapes and sizes such that the bread layer perimeter (not shown) is larger than the perimeters of the lower and upper tools 102, 104. In another embodiment, a lower depth (not shown) of the lower sandwich receiving cavity 112, extending from the lower shoulder face 122 to the inner base face 117, is larger than an upper depth (not shown) of the upper sandwich receiving cavity 140, which extends from the crimping face 134 to the inner base face 146. In a further embodiment, the lower depth is approximately seven-sixteenths of an inch and the upper depth is about five-sixteenths of an inch. It will be appreciated by one of ordinary skill in the art that the lower and upper depths may vary.

FIG. 1 also illustrates one embodiment of a mechanism for mounting 106 lower and upper tools 102, 104. In this embodiment, the lower tool 102 is provided with a lower arm 148 extending from the lower tool 102 and having a pivot end 150 with a width W₄ and a connection end 152 wherein the connection end 152 is attached to the lower tool 102. The upper tool 104 is provided with an upper arm 154 extending from the upper tool 104 and having a pivot end 156 with a width W₅ such that W₅ is greater than W₄, and a connection end 158 wherein the connection end 158 is attached to the upper tool 104. The pivot end 150 of the lower arm 148 is surrounded by the pivot end 156 of the upper arm 154. The upper arm 154 is pivotally connected to the lower arm 148 by a pivot pin 160 that extends through holes (not shown) disposed in the pivot ends 150, 156. The upper arm 154 may rotate around the pivot pin 160 along arc R₁.

In one embodiment, a length L₂ from the lower connection end 152 to the pivot pin 160 is greater than 1.5 inches and equal to a length L₃ from the upper connection end 158 to the pivot pin 160. In another embodiment, the lengths L₂, L₃ could be between 2 inches and 6 inches. In a further embodiment, the lengths L₂, L₃ are 3.5 inches. In certain embodiments, the lengths L₂, L₃ are greater than one-half inch. The lengths L₂, L₃ permit the inner edge 126 of the upper shoulder 124 to approach and engage the outer edge 118 of the lower shoulder 108 such that the upper shoulder face 132 is essentially perpendicular to the side walls 114. Advantageously, this embodiment allows the crust sections to be cut through and removed without ripping the bread slices. Additionally, the lengths L₂, L₃ provide a fulcrum that eliminates the need for excessive pressure when sealing the edges of the bread layers.

The upper arm 154 and lower arm 148, in one embodiment, is essentially hollow. In another embodiment, as shown in FIG. 1, the lower and upper arms 148, 154 have lower and upper support ridges 162, 164. Lower support ridges 162 may run vertically and horizontally. Upper support ridges 164 may also run vertically and horizontally, however, upper support ridges 164 may be recessed such that the upper arm 154 may surround the lower arm 148 when the bladeless sandwich making apparatus 100 is in a closed position (not shown).

The lower arm 148 may include a notch 166 adjacent to an attachment (not shown) to the lower tool 102. Likewise, the upper arm 154 may include a second notch 168 adjacent an attachment (not shown) to the upper tool 104. The notch 166 and the second notch 168 provide space for the crust sections (not shown) cut from the bread slices (not shown) to fall away from the lower and upper shoulders 108, 124 and allow the upper tool 104 to meet and crimp against the confronting lower shoulder face 122 to form the sealed edge 202 of the sandwich 200.

In some embodiments, the lower and upper tools 102, 104 have a back center region (not shown) that may be manipulated to release the crustless sandwich 200 with sealed edges 202 when the bladeless sandwich making apparatus 100 is in the open 101 position. The back center region of the lower and upper tools may be pliable and a user may push down on the pliable back center region to release the sandwich. In another embodiment (not shown), the back center region may further comprise a hole (not shown) that permits a pushing tool (not shown) or a finger of a user to push and remove the crustless sandwich 200 with sealed edges 202 when the apparatus 100 is in an open 101 position.

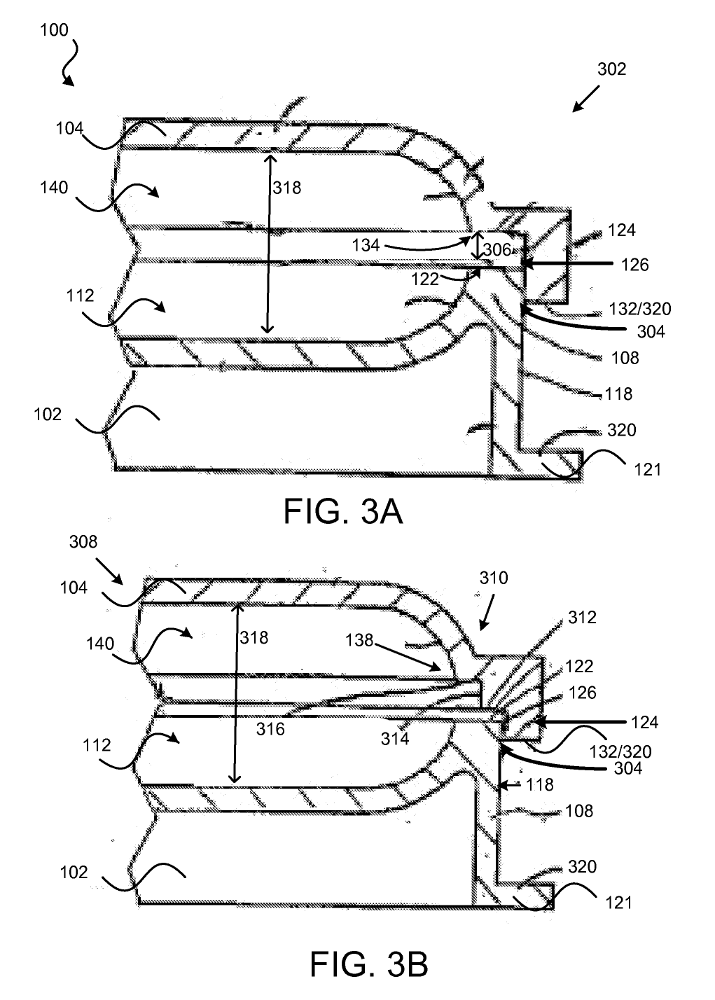

FIG. 3A is a cross-sectional side view of the bladeless sandwich making apparatus 100 illustrating a closed 302 position. In the closed 302 position, the upper tool 104 engages the lower tool 102 such that the upper shoulder 124 surrounds the lower shoulder 108. The inner edge 126 of the upper shoulder 124 engages the outer edge 118 of the lower shoulder 108 in an overlapping relationship such that a clearance 304, as defined by the space between the inner edge 126 of the upper shoulder 124 and the outer edge 118 of the lower shoulderlO8, is formed.

Some clearance 304 is necessary between the inner edge 126 of the upper shoulder 124 and the outer edge 118 of the lower shoulder 108 to allow the lower and upper tools 102, 104 to close 302. It is known that clearance 304 up to about twenty-eight thousandths of an inch will work well for cutting through the crust sections from the bread slices (not shown). In a preferred embodiment, the clearance 304 is between about ten- and twenty-thousandths of an inch. Clearances 304 above approximately twenty-eight thousandths of an inch can result in a ripping or tearing of the bread slices rather than a through cut of the bread slices. Clearances 304 between twenty-thousandths of an inch and twenty-eight thousandths of an inch result in minor tearing of the bread slices. Clearances 304 below approximately ten-thousandths of an inch results in a tight fit between the lower and upper shoulders 108, 124 when closed 302 and tends to make re-opening the apparatus 100 difficult. Acceptable clearances 304 can, however, be dependent upon variances in tool construction and tool materials.

The interaction at the interface between the inner edge 126 of the upper shoulder 124 and the outer edge 118 of the lower shoulder 108, as the upper tool 104 approaches the closed 302 position, results in the cutting and removal of the crust sections from the bread slices. As the upper shoulder 124 overlaps the lower shoulder 108, the crimping face 134 of the upper shoulder 124 confronts the lower shoulder face 122 to form a pressing station 306. The faces 122, 134 are used to form the newly cut sealed edges 202 of the sandwich 200.

FIG. 3B is an additional cross-sectional side view of another embodiment 308 of the bladeless sandwich making apparatus 100 illustrating a stepped configuration 310 of the crimping face 134 of FIG. 3A. In this embodiment, the upper tool crimping face 134 is stepped such that the crimping face 134 has a first confronting face 312 extending inwardly from the inner edge 126 of the upper shoulders 124, a vertical step wall 314, and a second confronting face 316 extending inwardly from the vertical step wall 314 to the inner crimping edge 138. Both the first confronting face 312 and the second confronting face 316 confront the lower shoulder face 122 when the apparatus 100 is in the closed 302, 308 position. In one embodiment, the first confronting face 312 has a width of about one-sixteenth of an inch. The inner edge 126 of the upper shoulder 124 defines a cut edge 212 of the sandwich 200.

Crimping with the stepped configuration 310 will permit a sandwich 200 to be more densely sealed on an outer sealed edge (not shown) then on an inner sealed edge (not shown) of the sandwich 200. It has been found that the stepped configuration 310 provides a good seal that is easily achieved with the same or less pressure applied to the apparatus 100 then with the flat crimping face 134 of FIG. 3A. Additionally, it may be easier to remove the sandwich 200 from the apparatus 100 when a stepped configuration 310 is used. While two steps 312, 316 are shown, one of ordinary skill in the art will appreciate that three or more steps could be used. Furthermore, while steps 312,316 on the upper crimping face 134 have been shown, steps on the lower shoulder face 122 could also be present.

When the bladeless sandwich making apparatus 100 is in a closed 302 position, the upper sandwich receiving cavity 140 is joined with the lower sandwich receiving cavity 112 to provide space 318 to hold the bread layers 204, 206 and filling material 208.

The gripping tab 121 connected to the lower tool 102 provides a gripping site 320 for one hand of a user while the upper shoulder face 132 of the upper tool 104 provides a lifting point 322 for a second hand of a user such that when force is applied against the gripping site 320 and the lifting point 322 in opposite directions, the upper tool 104 may be disengaged from the lower tool 102 resulting in an open position 101 of the bladeless sandwich making apparatus 100.

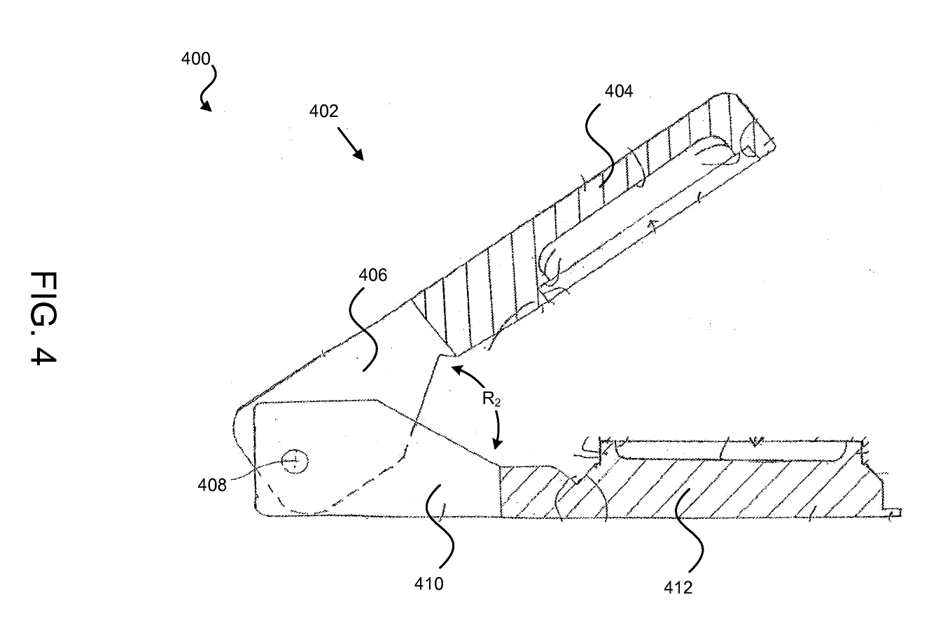

FIGS. 4 through 6 are cross-sectional views of another bladeless sandwich making apparatus 400. FIG. 4 depicts a side view 402 of the apparatus 400 illustrating the movement from an open to a closed position. The upper tool 404 is substantially similar to the upper tool 104 of apparatus 100 and has an upper arm 406 that moves about a pivot pin 408 around arc R₂. The upper arm 406 is moveable with respect to a lower arm 410 that is connected to a lower tool 412, which is substantially similar to lower tool 102 of apparatus 100.

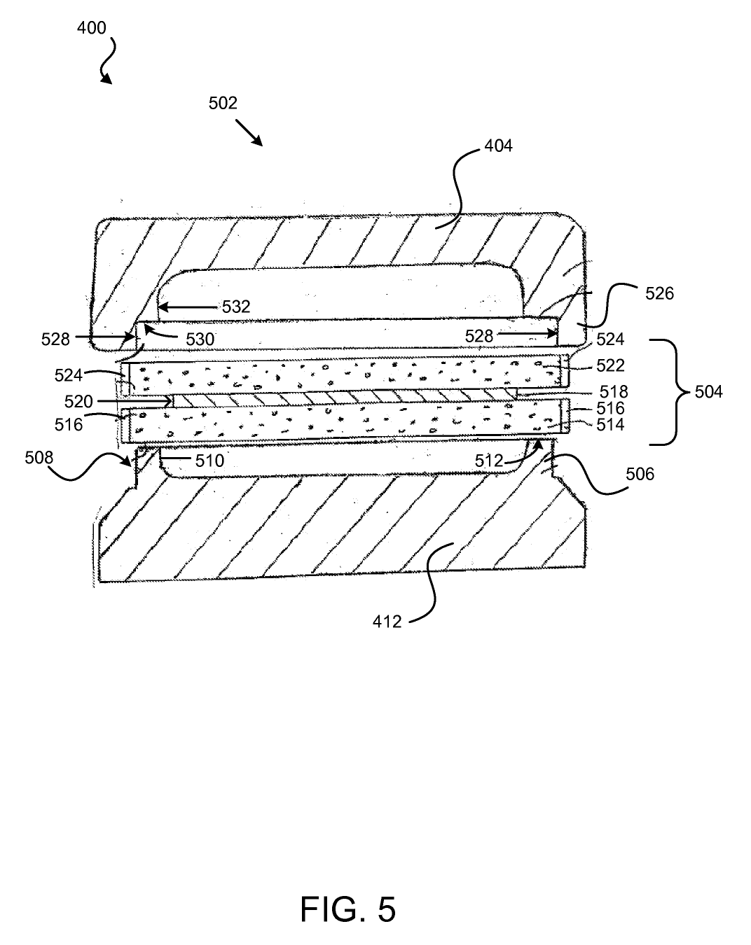

FIG. 5 depicts a front view 502 of a cross-section of the apparatus 400 in a partially open position having sandwich ingredients 504 disposed between upper and lower tools 404, 412. The lower tool 412 has a raised lower shoulder 506 with an outer edge 508, an inner edge 510, and a lower shoulder face 512. A bottom bread layer 514 rests on the lower shoulder face 512 of the lower tool 412 oriented such that bread crust sections 516 extend beyond an outer edge 508 of the lower shoulder 506. Sandwich filling material 518 is placed on top of the bottom bread layer 514 such that edges 520 of the filling material 518 do not extend beyond an inner edge 510 of the lower shoulder 506. A top bread layer 522 rests on top of the filling material 518 and has crust sections 524 that align substantially with the crust sections 516 of the bottom bread layer 514.

An upper tool 404 of apparatus 400 has a raised upper shoulder 526 with an inner edge 528, a crimping face 530 disposed adjacent to the inner edge 528, and an inner crimping edge 532. The inner edge 528 of the upper shoulder 526 is aligned such that the upper shoulder 526 may surround the lower shoulder 506 when the apparatus 400 is in a closed position similar to the closed position 302 of apparatus 100 in FIG. 3. The crust sections 516, 524 extend beyond the inner edge 528 of the upper shoulder 526 such that when the apparatus 400 is in a closed position, the crust sections 516, 524 will be cut through and removed from the bread layers 514, 522. Additionally, the crimping face 530 is aligned with the lower shoulder face 512 such that when the apparatus 400 is in a closed position, the crimping face 530 will confront the lower shoulder face 512 to press newly cut edges 212 of the bread layers 514, 522 together to form a seal 202.

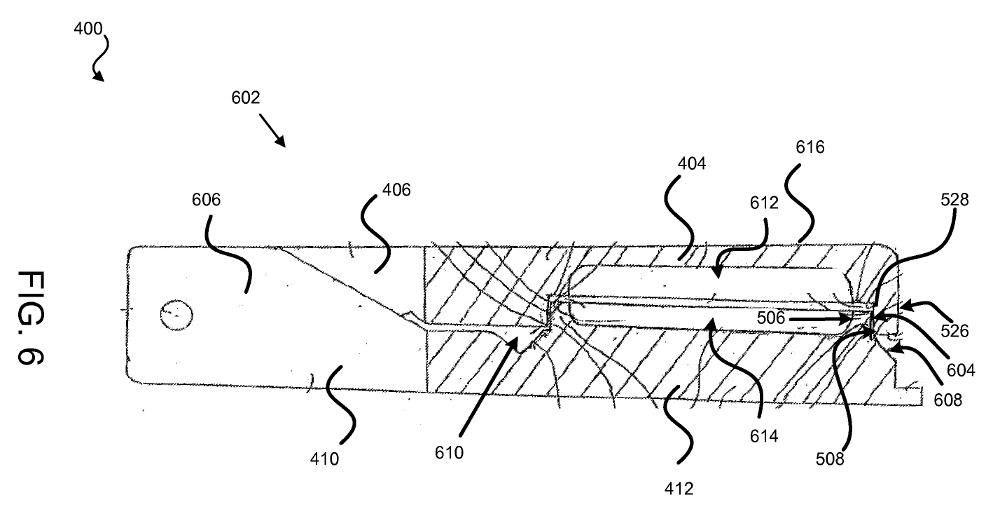

FIG. 6 depicts a side view of a cross-section of the apparatus 400 in a closed 602 position. In the closed 602 position, the upper shoulder 526 of the upper tool 404 surrounds the lower shoulder 506 of the lower tool 412 such that a clearance 604, as defined as the distance between the inner edge 528 of the upper shoulder 526 and the outer edge 508 of the lower shoulder 506, is formed. In the closed 602 position, the upper arm 406 lies flat against the lower arm 410. In this closed 602 position, the arms 406, 410 may be held together has a handle 606 that may be squeezed or pinched together to apply sealing pressure on the upper and lower tools 404, 412. The lower tool 412 may also include sloped edges 608, as well as a notch 610 disposed in the lower arm 410, such that when the crust sections 516, 524 are cut, the crust sections 516, 524 will slide away from the apparatus 400 to prevent interference with forming the sealed edges 202 of the sandwich 200. The upper tool 404 further comprises an upper sandwich receiving cavity 612 defined by the upper shoulder 526. The lower tool 412 further comprises a lower sandwich receiving cavity 614 defined by the lower shoulder 506. The upper and lower sandwich receiving cavities 612, 614, when the apparatus 400 is in the closed position 602, provides sufficient space to accommodate the bottom and top bread layers and filling material (not shown).

In another embodiment, not shown, the upper and lower tools 404, 412 have upper and lower arms 406, 410 extending from the upper and lower tools 404, 412 but are not connected by a pivotal pin 408 or other pivotal connection (not shown). The upper arm 406 may operate as a handle for the upper tool 404 and the lower arm 410 may operate as a handle for the lower tool 412. In this embodiment, the upper arm 406 is not connected to the lower arm 406 when the apparatus 400 is in an open position. In a closed 602 position, the upper arm 406 may meet the lower arm 410 to operate as a single handle 606 for the apparatus 400. In another embodiment, one of the upper and lower arms 406, 410 may be nested in the opposing arm 406, 410. In a further embodiment, the upper and lower arms 406, 410 may not be nested such that the upper arm 406 sits against the lower arm 410 to make a handle 606 when the apparatus 400 is in the closed position 602.

In yet another embodiment, the upper tool 404 with extending upper arm 406 may confront the lower tool 412 with extending lower arm 410 such that the extending upper arm 406 and the extending lower arm 410 extend from the upper and lower tools 404, 412 in different orientations. In this embodiment, the upper and lower arms 406, 410 would not be connected to form a single handle 606. In additional embodiments, the upper arm 406 may extend from a back surface 616 of the upper tool 404 such that it operates as a single handle (not shown) to apply pressure to the apparatus 400 when in the closed position 602. It is apparent to one of ordinary skill in the art that the upper and lower arms 406, 410,may extend from the upper and lower tools 404,412 at varying positions with respect to the upper and lower tools 404,412, may be connected or not, and may meet or not when the apparatus is in a closed 602 position.

Additionally, while a hinge is not required, a hinge may be attached to the upper and lower tools 404, 412 at position substantially opposite the upper and lower arms 406, 410. The hinge may be attached any distance from the upper and lower tools 404, 412.

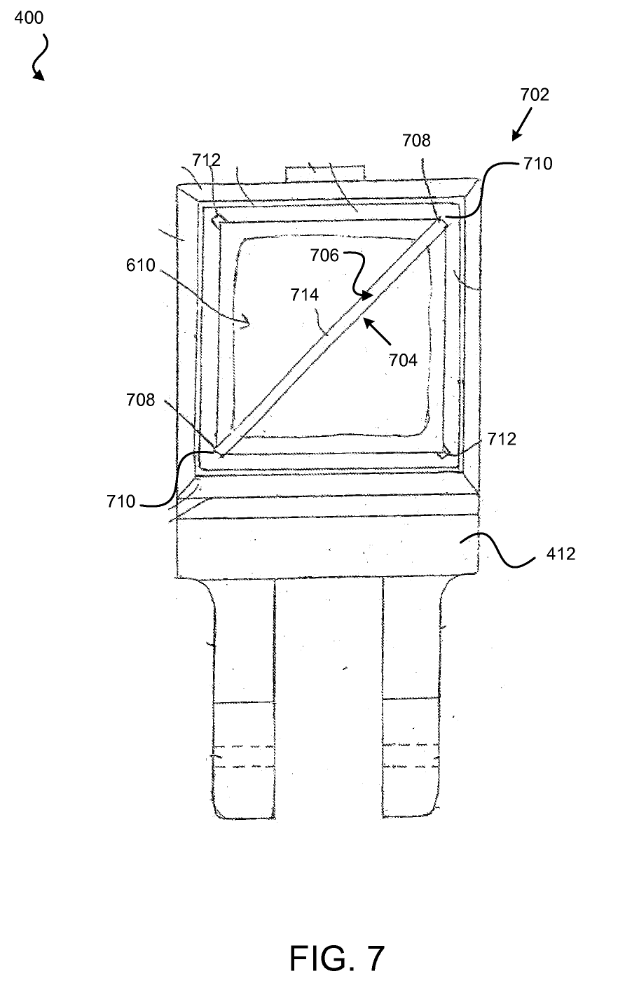

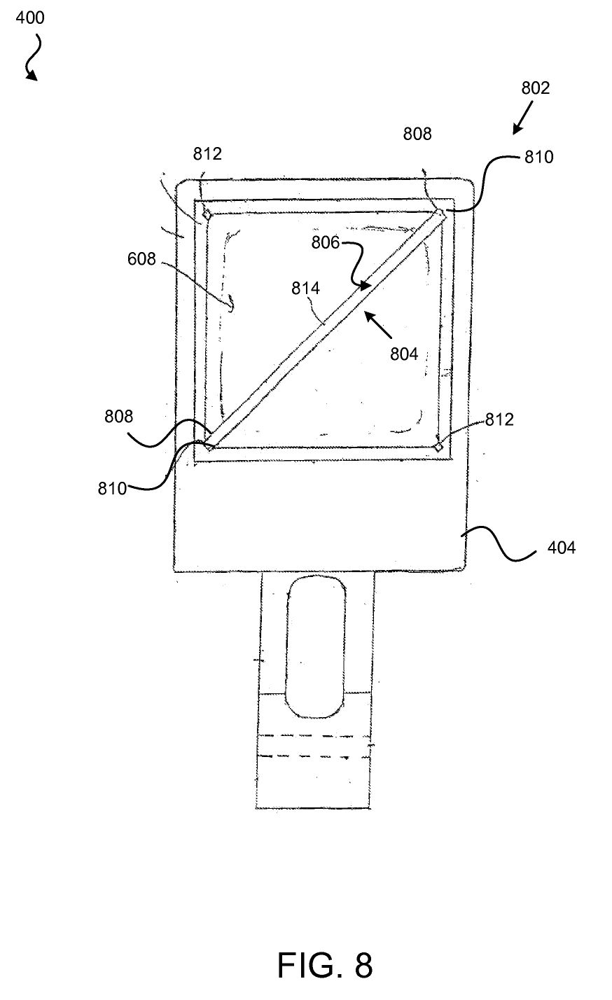

FIG. 7 is a top plan view 702 of the lower tool 412 of the apparatus 400 illustrating the lower sandwich receiving cavity 610 having a lower impression bar 704 in a diagonal orientation. In one embodiment, the lower impression bar 704 may be used to compress an outer surface of a sandwich along a horizontal plane 706 of the lower impression bar 704 for decorative purposes. FIG. 8 is a bottom plan view 802 of the upper tool 404 of the apparatus 400 illustrating the upper sandwich receiving cavity 608 having an upper impression bar 804 in a diagonal orientation. The upper impression bar 804 may be used to compress an outer surface of a sandwich along a horizontal plane 806 of the upper impression bar 804 for decorative purposes.

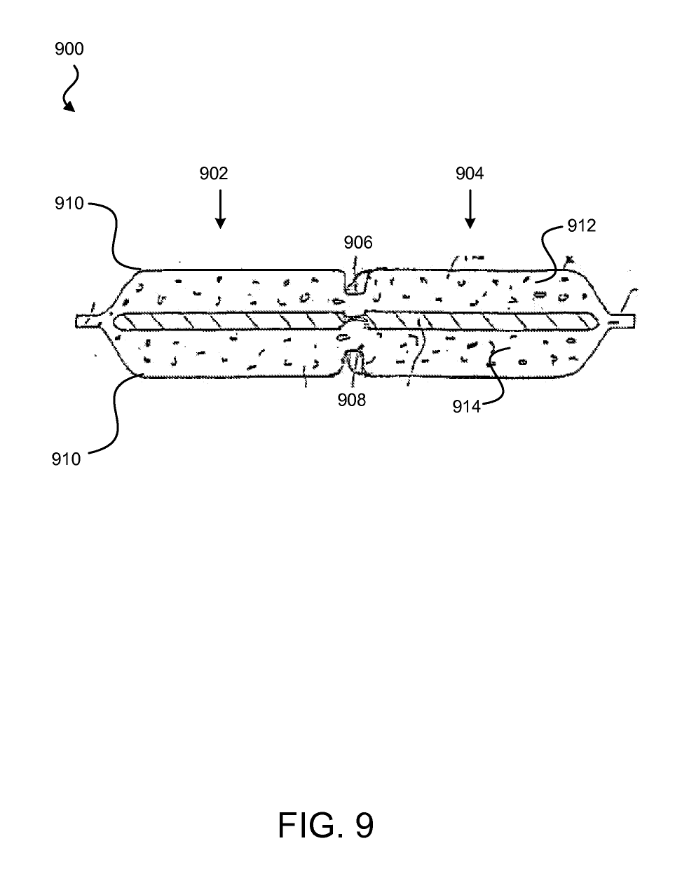

FIG. 9 is a cross-section of a sandwich 900 made with the apparatus 400 having impression bars 704, 804 inserted in the upper and lower sandwich receiving cavities 608, 610. In this embodiment, the impression bars 704, 804 may be used in conjunction in corresponding orientations to make a sandwich 900 which may be divided into two halves 902, 904 that can be separated for eating. The sandwich 900 has received upper and lower indentations 906, 908 that define the two halves 902, 904.

Impression bars 704, 804 may partially extend toward the opposite impression bar 704, 804 to leave an indentation that is decorative in nature in an outer surface 910 of the sandwich 900. In another embodiment, impression bars 704, 804 may completely extend toward the opposite impression bar 704, 804 to press and seal upper and lower bread layers 912, 914 together to divide the sandwich in two halves 902, 904.

The bars are preferably removeably placed in the sandwich receiving cavities 608, 610 of the upper and lower tools 404, 412 such as by a friction fit of ends 708 of the impression bar 704 in comer slots 710 and the ends 808 of the impression bar 804 in comer slots 810. Opposite comer slots 712, 812 may also be provided so that additional impression bars 704, 804 may be inserted to divide a sandwich into quarters (not shown). In this further embodiment, the impression bars 704, 804 would from an “X” configuration. Center regions 714, 814 of impression bars 704, 708 may be slotted (not shown) such that the impression bars 704, 804 may cross in the center regions 714, 814. One of ordinary skill in the art will appreciate that various other arrangements of impression bars 704, 804 may be provided anywhere along the periphery of the sandwich receiving cups 608, 610 and that the impression bars 704, 804 may be secured either removeably or non-removeably by other means such as adhesive and the like.

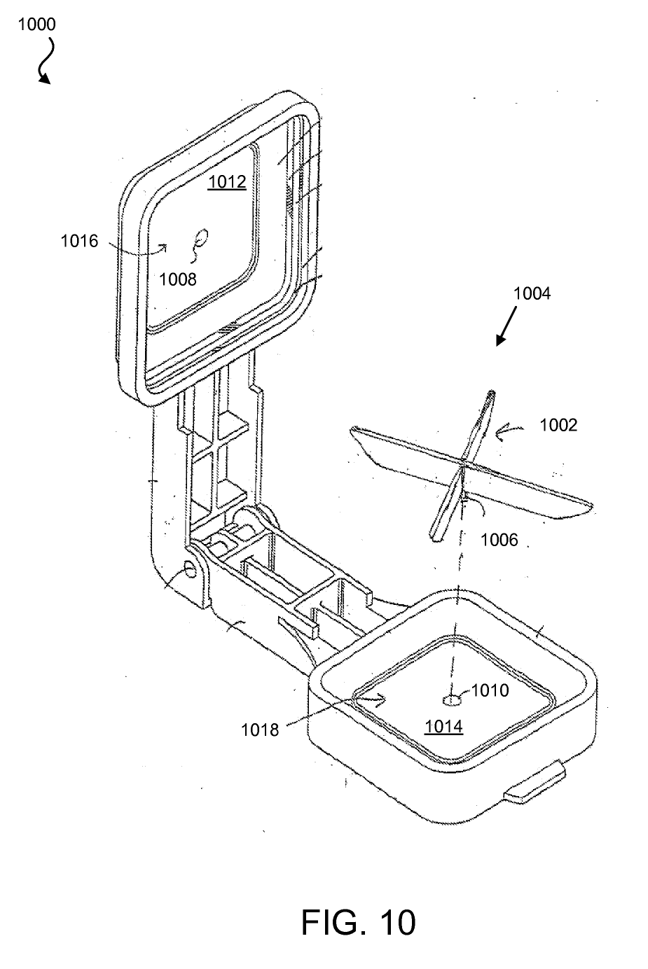

In another embodiment of a bladeless sandwich making apparatus 1000, illustrated in FIG. 10, impression bars 1002 for dividing sandwiches or decorating sandwiches may be formed as a unitary impression bar assembly 1004 with a post 1006 extending centrally from the assembly 1004. The post 1006 is adapted to be received by receiving holes 1008, 1010 disposed in the bottom surface faces 1012, 1014 of the upper and lower sandwich receiving cavities 1016, 1018. The impression bar assembly 1004 may be configured to be removable such that the assembly 1004 may removed and the apparatus 1000 used without an impression bar assembly 1004 or may be replaced with a second impression bar assembly 1004. Furthermore, an impression bar assembly 1004 may be attached to either the upper sandwich receiving cavity 1016, the lower sandwich receiving cavity 1018, or both cavities 1016, 1018.

The post 1006, when extended through a receiving hole 1008, 1010, may be used as a pushing button (not shown) in some embodiments. When the apparatus 1000 is in a closed position (not shown) a user may apply force to the end of the post 1006 in a direction towards the sandwich so as to imprint a design or create a tighter seal in the sandwich as imprinted by the impression bar assembly 1004. Furthermore, when the apparatus 1000 is in an open position, as shown in FIG. 10, force may be applied to the end of the post 1006 in the direction towards the sandwich so as to aide in the release of the sandwich, such as the sandwich 900, from either the upper sandwich receiving cavity 1016 or the lower sandwich receiving cavity 1018.

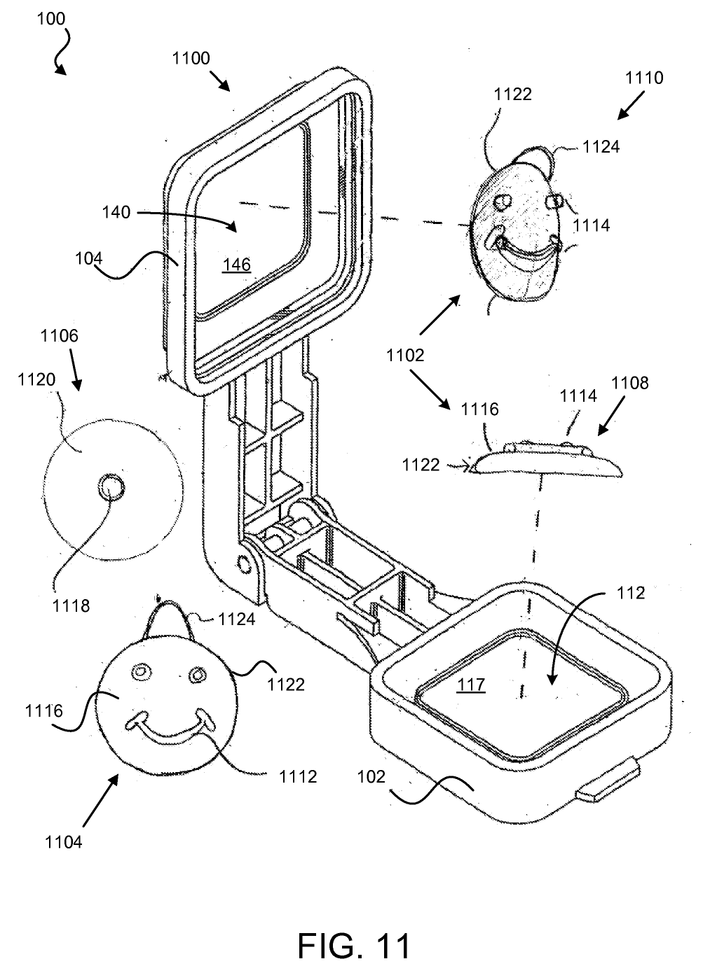

FIG. 11 illustrates a perspective view 1100 of the apparatus 100 adapted for use with an impression design plate 1102. A front view 1104, back view 1106, side view 1108, and perspective view 1110 of the impression design plate 1102 are depicted in FIG. 11. An impression design plate 1102 may be used similarly to impression bars 704, 804 configured for adding design to the outer surface 214, 910 of sandwiches 200, 900. The impression design plate 1102 is configured to compress the outer surface 214, 910 of sandwiches 200, 900 when the apparatus 100 is in a closed 302 position such as depicted in FIG. 3A. The impression design plate 1102 may have textured marking feature 1112, 1114 disposed on its front surface 1116 that may be an indented marking feature 1112 or a raised marking feature 1114. A marking feature 1112, 1114 may be a decorative design, picture, symbol, words, or the like.

The impression design plate 1102 may be configured to be removeably fit in the lower sandwich receiving cavity 112, the upper sandwich receiving cavity 140, or both cavities 112, 140. The impression design plate 1102 may further comprise a suction cup 1118 disposed on a back surface 1120 that permits the impression design plate to be removeably attached to the inner base face 117 of the lower tool 102 or the inner base face 146 of the upper tool 104.

In another embodiment, the back surface 1120 may further comprise a post (not shown), like the post 1006 of FIG. 10, extending centrally from the impression design plate 1102. In this embodiment, the impression design plate 1102 with post may be used with the bladeless sandwich making apparatus 1000 as described in FIG. 10. Alternatively, the impression design plate 1102 may be adapted to frictionally fit against the inner base faces 117, 146. One of ordinary skill in the art will appreciate that impression design plates 1102 may be secured either removeably or non-removeably by other means such as adhesive and the like. A side 1122 of the impression design plate 1102 may be further provided with a handle 1124 to allow a user to place and remove the impression design plate 1102 from the apparatus 100.

In another embodiment, the impression design plate 1102 may have a minor textured surface that does not impress an image onto the outer surface 214, 910 of the sandwich 200, 900, but prevents the outer surface 214, 910 of a sandwich 200, 900 from sticking to the inner base faces 117, 146 during sandwich 200, 900 removal from the apparatus 100.

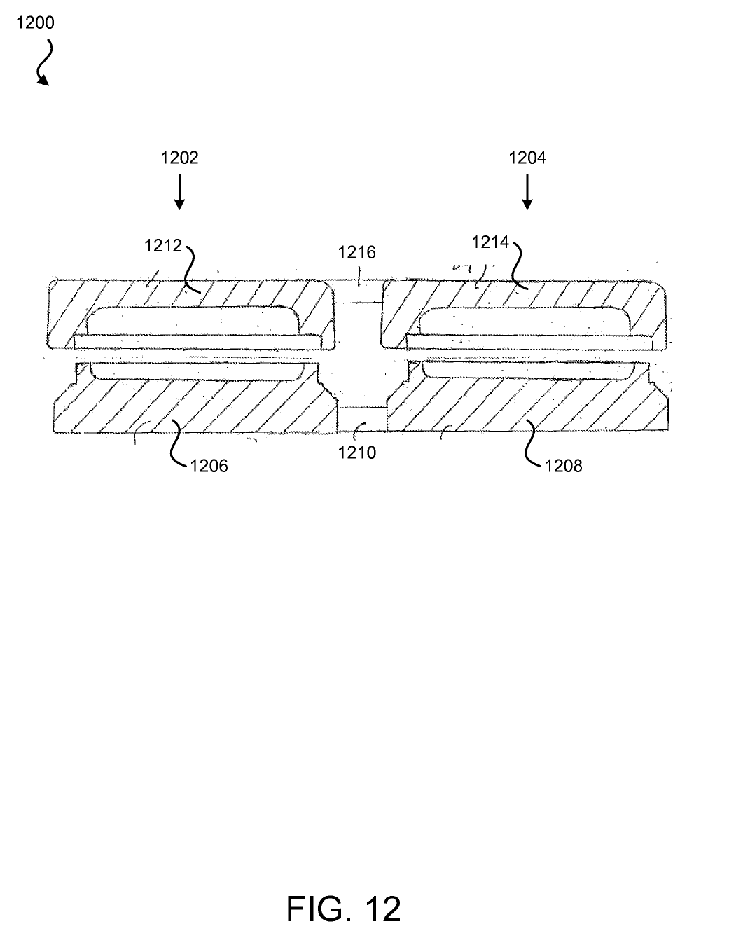

FIG. 12 illustrates two bladeless sandwich making apparatuses 1202, 1204 connected together. Each apparatus 1202, 1204 may be substantially similar to the bladeless sandwich making apparatus 100, 400, 1000 previously described. In some instances, particularly in commercial establishments such as delicatessens and sandwich shops, it may be desirable to make a plurality of sandwiches (not shown) such as sandwiches 200, 900 in a single pressing operation. For this purpose, a plurality 1200 of sandwich making apparatuses 100, 400, 1000 may be joined together. As shown in FIG. 12, lower tools 1206, 1208 of two individual sandwich making devices 1202, 1204 are joined together by a connector 1210 configured to extend between the adjacent lower tools 1206, 1208. The connector 1210 may be attached to the lower tools 1206, 1208 with adhesive, strips of hook and loop, tape, or the like. Additionally, the lower tools 1206, 1208 may be formed as an integral unit by molding or casting the two lower tools 1206, 1208 as a single integral piece.

Two upper tools 1212, 1214 may also be joined together by a second connector 1216 that, like the connector 1210, may be attached to the upper tools 1212, 1214 with adhesive, strips of hook and loop, tape, or the like. Additionally, the upper tools 1212, 1214 may also be formed as an integral unit by molding or casting the two upper tools 1212, 1214 as a single integral piece. One of ordinary skill in the art will appreciate that the connectors 1210, 1216 may connect the tools together at various locations other than that shown in FIG. 12. Additional bladeless sandwich making apparatuses 1202, 1204 may be connected, as desired. When using a plurality 1200 of bladeless sandwich making apparatuses, sandwich ingredients may be arranged on as many of the lower tools 1206, 1208 as desired. The upper tools 1212, 1214 are operated together to press and make a plurality (not shown) of sandwiches simultaneously.

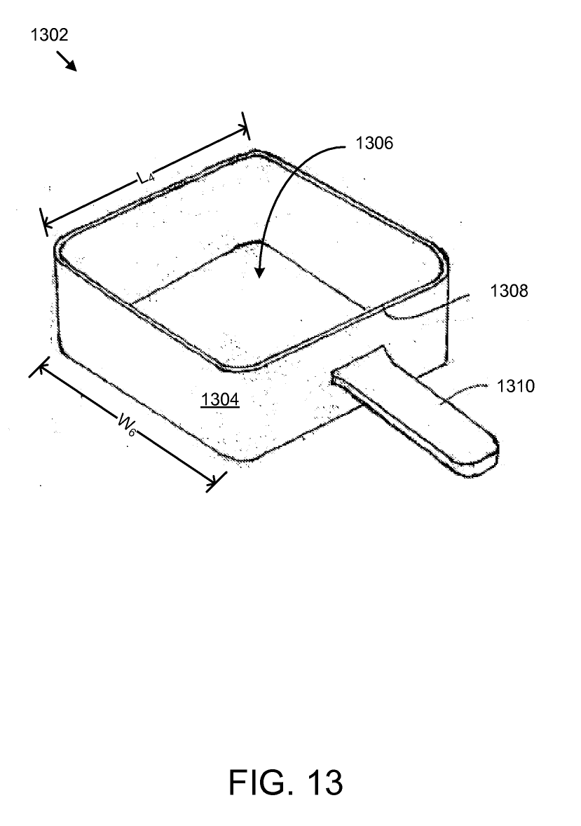

FIG. 13 illustrates a perspective view of a filling material cup 1302 that may be further provided for use in making sandwiches with a bladeless sandwich making apparatus such the apparatus 100. The filling material cup 1302 may be made of a manufacturing material appropriate for the type of filling material (not shown) and heating of the filling material to be used for making sandwiches, such as sandwiches 200, 900. The manufacturing material may include, but not be limited to, plastic, metal, ceramic, glass, and the like. In one embodiment, the manufacturing material is microwaveable. In another embodiment, the manufacturing material is heat resistant and may be used on a stove burner or in a conventional oven.

The filling material cup 1302 is provided with a width W₆ and a length L₄ such that W₆ and L₄ are shorter than W₃ and L₁ of the lower sandwich receiving cavity 112 when the filling material cup is inverted (not shown). The filling material cup 1302 is sized and shaped for use with the bladeless sandwich making apparatus 100 in one example. If the bladeless sandwich making apparatus 100 is substantially square, as shown in FIG. 1 in this example, the filling material cup 1302 will be substantially square with slightly smaller dimensions then the dimensions of the sandwich receiving cavities 112, 140.

The filling material cup 1302 will determine dimensions of a sandwich filling (not shown) that will fit within the dimensions of the sandwich receiving cavities 112, 140 to allow the bread edges (not shown) to be sealed without interference from the sandwich filling. For example, if the sandwich receiving cavities 112, 140 are substantially rectangular and sized with a length L₁ and width W₃ of about two and seven-eighths inches, the filling material cup 1302 may be substantially rectangular with length L₄ and width W₆ of about two and five-eighths inches. In another example, if the sandwich receiving cavities 112, 140 are sized with a length L₁ and width W₃ of about three and one-eighth inches, the filling material cup 1302 will have a length L₄ and width W₆ about three inches. The filling material cup 1302, in one embodiment, may have sides 1304 about one inch deep. The filling material cup 1302, in another embodiment, may have sides 1304 with other depths.

The filling material cup 1302 is also provided with a volume 1306 and a cup edge 1308. The filling material cup 1302 may also be provided with a handle 1310 to aid in transport of and cooking with the filling material cup 1302 containing filling material as well as in aiding in inversion of the filling material cup 1302 to disperse filling material onto a lower bread layer (not shown). The filling material cup 1302 may also be provided, in another embodiment not shown, with slightly sloped sides 1304 to facilitate removal of the filling material from the filling material cup 1302.

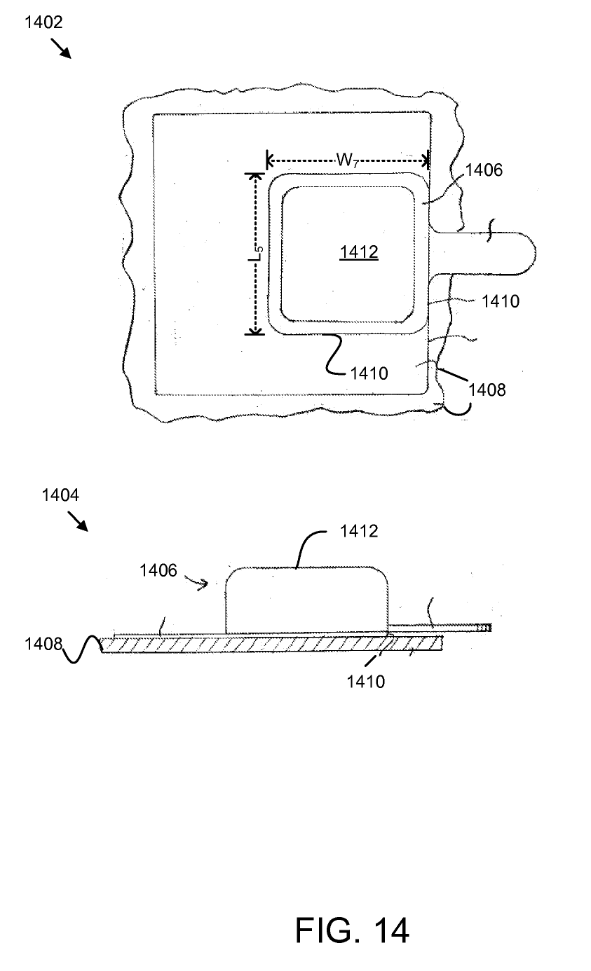

FIG. 14 illustrates a top view 1402 and a side view 1404 of an inverted filling material cup 1406 configured to shape and cut filling material slices 1408 such as a meat slice and a cheese slice. The inverted filling material cup 1406 may be aligned, as in view 1402, such that a cup edge 1410 of the inverted filling material cup 1406 may determine a width W₇ and a length L₅ of the filling material slices 1408 to be used in a sandwich (not shown). A user may apply pressure on a bottom surface 1412 of the filling material cup 1406 to cut the slices 1408 with the cup edge 1410 to the appropriate size for the sandwich. It has been found that a sharp cup edge (not shown) is not necessary for cutting sandwich filling material 1408 and a blunt cup edge 1410 is satisfactory to cut sandwich filling material 1408. In another embodiment, the cup edge 1410 may be in a beveled shape to facilitate cutting of sandwich filling material 1408. In a further embodiment, the cup edge 1410 may be serrated. Alternatively, a user may cut the slices 1408 around the cup edge 1410 using another cutting device (not shown), such as a knife.

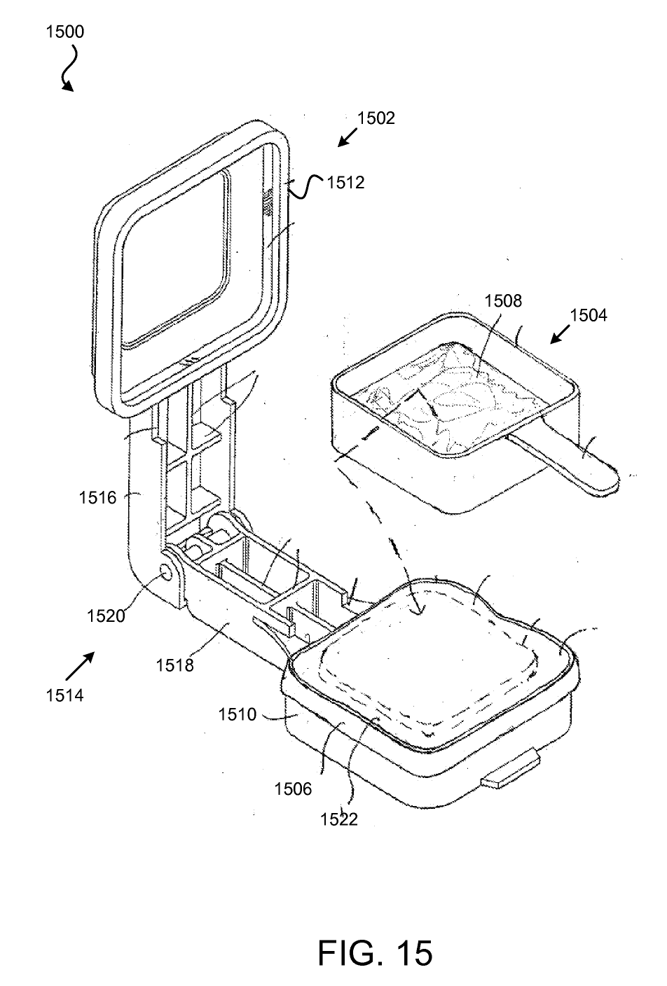

The present invention also provides a system for making sandwiches 200, 900. FIG. 15 illustrates one embodiment of the system 1500 comprising a bladeless sandwich making apparatus 1502, a filling material cup 1504, bread layers 1506, sandwich filling material 1508 configured to fit in the filling material cup 1504, and an impression design plate (not shown) configured to interface between the apparatus 1502 and the at least one layer of bread 1506. The bladeless sandwich making apparatus 1502, in one embodiment, includes a lower tool 1510, an upper tool 1512, and a mechanism for mounting 1514. In a further embodiment, the mechanism for mounting 1514 that includes upper and lower arms 1516, 1518 that pivot relative to each other around a pivot pin 1520 such that the upper tool 1512 may engage the lower tool 1510 in a closed position (not shown) or disengage the lower tool 1510 in a substantially open position, such as in FIG. 15. In one embodiment, the pivot pin 1520 is placed 3.5 inches away from the lower and upper tools 1510, 1512 to facilitate the lower and upper tools 1510, 1512 engaging in a substantially vertical orientation. In other embodiments, the pivot pin 1520 is placed greater than 1.5 inches away from the lower and upper tools 1510, 1512. In certain embodiments, the pivot point 1520 is placed between 2 inches and 6 inches away from the lower and upper tools 1510, 1512. In some embodiments, the pivot point 1520 is placed one-half inch away from the lower and upper tools 1510, 1512. Additionally, the upper and lower arms 1516, 1518 may function as a handle (not shown) when the apparatus in a partially closed or closed position (not shown). The handle may be squeezed to apply pressure against the lower and upper tools 1510, 1512 such that the sandwich crusts are removed and the bread edges are crimped and sealed.

The bread layer 1506 is configured to sit on the lower tool 1510. The filling material cup 1504, containing filling material 1508, may be inverted to place filling material 1508 on top 1522 of the bread layer 1506.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

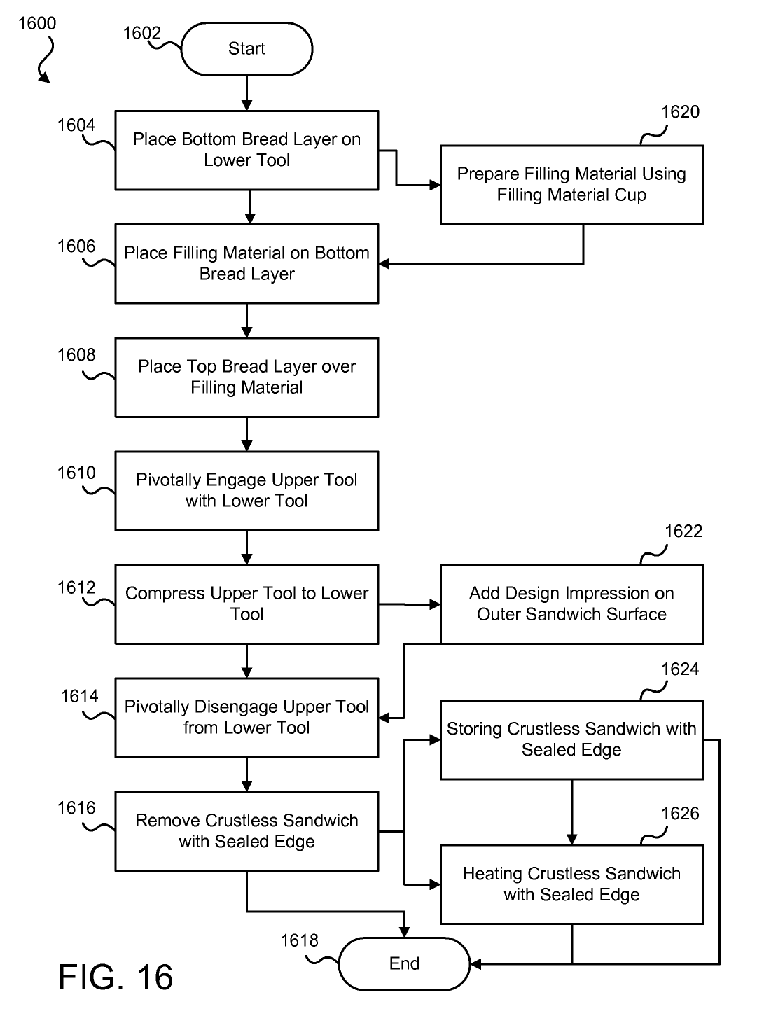

FIG. 16 illustrates one embodiment of a sandwich making method 1600 in accordance with the present invention. The method 1600 may begin 1602 and may include placing 1604 a bottom bread layer on a lower tool, placing 1606 filling material on the bottom bread layer, placing 1608 a top bread layer over the filling material, pivotally engaging 1610 an upper tool with the lower tool, compressing 1612 the upper tool relative to the lower tool, pivotally disengaging 1614 the upper tool from the lower tool, and removing 1616 a crustless sandwich with a sealed edge. Reference may be made to FIGS. 1-15 to illustrate the method 1600 in greater detail, but does not limit the scope of the method 1600.

In one embodiment, a bottom bread layer such as the bottom bread layer 514 is placed 1604 on a lower tool such as the lower tool 102 of apparatus 100 in an open position. Subsequently, a filling material such as the filling material 518 is placed 1606 in the center of the bottom bread layer 514 aligned with a lower sandwich receiving cavity such as the lower sandwich receiving cavity 112. Next, a top bread layer such as the top bread layer 522 is placed 1608 over the filling material 518 such that the top bread layer 522 aligns with the bottom bread layer 514. An upper tool such as the upper tool 104 is next pivotally engaged 1610 with the lower tool 102 such that the upper tool 104 aligns with the lower tool 102 and a pivotal connection becomes a handle like the handle 606. Subsequently, the upper tool 104 is compressed 1612 relative to the lower tool 102 such that the upper tool 104 passes through the top bread layer 522 and the bottom bread layer 514, operatively cutting crust sections such as the crust sections 516, 524 from the bottom and top bread layers 514, 522, while cut edges such as the cut edges 212 are sealed together forming a crustless sandwich such as the crustless sandwich 200 with a sealed edge such as the sealed edge 202. Next, the upper tool 104 is pivotally disengaged 1614 from the lower tool 102 and the crustless sandwich 200 is removed 1616 from the bladeless sandwich making apparatus 100. In certain embodiments, the method 1600 may end 1618 following step 1616.

In a further embodiment, the user may prepare 1620 filling material 518 using a filling material cup such as the filling material cup 1302 prior to placing 1606 the filling material 518 on the bottom bread layer 514. The filling material cup 1302 may be inverted to release the filling material 518 from the filling material cup 1302 and position the filling material 518 onto the center of the bottom bread layer 514. Preparation 1620 of filling material 518 may include one or more of measuring, shaping, cutting, and cooking (not shown) filling material 518 using the filling material cup 1302. Cooking the filling material 518 using the filling material cup 1302 may occur in a microwave, on a stove burner, in an oven, or over a flame.

The user, in another embodiment, may add 1622 a mirror marking feature impression on an outer sandwich surface such as surface 214 prior to pivotally disengaging 1614 the upper tool 104 from the lower tool 102. In certain embodiments, a user may press (not shown) on a back side of the upper to lower tools to facilitate removal of the crustless sandwich.

In yet another embodiment, the user may store 1624 the crustless sandwich 200 with the sealed edge 202 after removing 1616 the crustless sandwich 200 from the bladeless sandwich making apparatus 100. A user may store 1624 the crustless sandwich at ambient temperatures or at chilled or freezing temperatures. The method may also place (not shown) a sealing wrap layer below the bottom bread layer and a sealing wrap layer above the top bread layer prior to pivotally engaging and compressing the upper tool relative to the lower tool.

Yet a further embodiment of the method 1600 permits a user to heat 1626 the crustless sandwich 200 after removing 1616 the crustless sandwich 200 from the bladeless sandwich making apparatus 100 and, in some embodiments, after storing 1624 the crustless sandwich 200. Heating 1626 the crustless sandwich 200 with sealed edges 202 may be with a toaster, an oven, a microwave, a grill, a flame, or the like. The method 1600 may end 1618 after one or more steps 1616, 1624, 1626. The method 1600 may also include additional steps (not shown) for making a second crustless sandwich 200 with sealed edges 202.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A bladeless sandwich making apparatus for making crustless bread sandwiches: with sealed edges, the apparatus comprising:
a lower tool having a raised lower shoulder with a lower shoulder face and a lower sandwich receiving cavity;
an upper tool having a raised upper shoulder, a crimping face configured to confront the lower shoulder face of the lower tool, and an upper sandwich receiving cavity; and
a mechanism for mounting the lower tool and the upper tool, the mechanism for mounting configured to permit the upper tool to move relative to the lower tool such that the apparatus has an open position with the upper tool substantially separated from the lower tool, and a closed position with the upper tool substantially engaged with the lower tool and the upper shoulder in an overlapping relationship relative to the lower shoulder, the mechanism for mounting comprising an upper arm extending from the upper tool to a pivotal connection and a lower arm extending from the lower tool to a pivotal connection, the upper arm pivotally connected to the lower arm.

2. The bladeless sandwich making apparatus of claim 1, wherein a length between the pivotal connection and the upper tool is equal to a length between the pivotal connection and the lower tool and the lengths are greater than one-half inch

3. The bladeless sandwich making apparatus of claim 1, wherein a length between the pivotal connection and the upper tool is equal to a length between the pivotal connection and the lower tool and the lengths are greater than one and one-half inches.

4. The bladeless sandwich making apparatus of claim 1, wherein the raised lower shoulder further comprises an inner edge defining the lower sandwich receiving cavity with a width and a length, and an outer edge having a lower tool perimeter less than a bread slice perimeter.

5. The bladeless sandwich making apparatus of claim 4, wherein the raised upper shoulder further comprises an inner edge having an upper tool perimeter greater than the lower tool perimeter.

6. The bladeless sandwich making apparatus of claim 5, wherein a clearance between the inner edge of the upper shoulder and the outer edge of the lower shoulder is between ten-thousandths of an inch and twenty-thousandths of an inch.

7. The bladeless sandwich making apparatus of claim 1, wherein the apparatus is a hand-held device and the mechanism for mounting comprises a hinged handle.

8. The bladeless sandwich making apparatus of claim 1, wherein the crimping face has a width that is between one-sixteenths and one-eighths of an inch.

9. The bladeless sandwich making apparatus of claim 1, wherein the crimping face is substantially flat.

10. The bladeless sandwich making apparatus of claim 1, wherein the crimping face further comprises a graduated step to provide more than one vertically-spaced confronting faces.

11. The bladeless sandwich making apparatus of claim 1, wherein the lower tool further comprises a gripping tab extending from the lower tool.

12. The bladeless sandwich making apparatus of claim 1, further comprising a filling material cup with a volume and a cup edge configured to align with the lower sandwich receiving cavity.

13. The bladeless sandwich making apparatus of claim 12, wherein the filling material cup may be used to cook filling material before making a sandwich.

14. The bladeless sandwich making apparatus of claim 1, further comprising an impression bar configured to removeably fit in the upper and lower sandwich receiving cavities, wherein the impression bar compresses the sandwich along the horizontal plane of the impression bar.

15. The bladeless sandwich making apparatus of claim 1, further comprising an impression design plate having a textured marking feature, the impression design plate configured to removeably mount in the upper and lower sandwich receiving cavities, and wherein the impression design plate compresses the sandwich along the horizontal plane of the impression design plate imprinting a mirror marking feature on an outer sandwich surface when the bladeless sandwich making apparatus is in a closed position.

16. The bladeless sandwich making apparatus of claim 1, wherein a back center region of the lower and upper tools may be manipulated to release the sandwich when the bladeless sandwich making apparatus is in the open position.

17. A bladeless sandwich making system for making crustless bread sandwiches with sealed edges, the system comprising:
a bladeless sandwich making apparatus, the bladeless sandwich making apparatus comprising:
a lower tool having a gripping tab extending from the lower tool and a raised lower shoulder with an inner edge defining a lower sandwich receiving cavity with a width and a length, an outer edge having a lower tool perimeter less than a bread slice perimeter, and a lower shoulder face;
an upper tool having a raised upper shoulder with an inner edge having an upper tool perimeter greater than the lower tool perimeter, an outer edge, a top shoulder face, a crimping face configured to confront the top shoulder face of the lower tool, and an inner crimping edge defining an upper sandwich receiving cavity with a width and a length substantially equal to the width and the length of the lower sandwich receiving cavity;
a clearance between the inner edge of the upper shoulder and the outer edge of the lower shoulder, the clearance having a width less than approximately twenty-eight thousandths of an inch; and p2 a mechanism for mounting the lower tool and the upper tool, the mechanism for mounting configured to permit the upper tool to move relative to the lower tool such that the apparatus has an open position with the upper tool substantially separated from the lower tool, and a closed position with the upper tool substantially engaged with the lower tool and the upper shoulder in an overlapping relationship relative to the lower shoulder, the mechanism for mounting comprising an upper arm extending from the upper tool and a lower arm extending from the lower tool, the upper arm pivotally connected to the lower arm at a length greater than one-half inch from the upper and lower tools;
a filling material cup having a width and a length substantially less than the width and the length of the lower sandwich receiving cavity, a volume, and a cup edge;
an impression design plate having a textured marking feature, the impression design plate configured to removeably fit in the upper and lower sandwich receiving cavities, and wherein the impression design plate compresses the sandwich along the horizontal plane of the impression design plate imprinting a mirror marking feature on an outer sandwich surface when the bladeless sandwich making apparatus is in a closed position;
bottom and top bread layers having widths and lengths greater than the width and the length of the lower sandwich receiving cavity; and
a sandwich filling material.

18. A method for making crustless sandwiches with sealed edges using a bladeless sandwich apparatus, the method comprising: placing a bottom bread layer on a lower tool of a bladeless sandwich making apparatus configured in an open position;
placing filling material on the bottom bread layer such that the filling material is substantially placed in the center of the bottom bread layer and aligning with a lower sandwich receiving cavity;
placing a top bread layer over the filling material such that the top bread layer aligns with the bottom bread layer;
pivotally engaging an upper tool of the bladeless sandwich making apparatus with the lower tool such that the upper tool aligns with the lower tool and a pivotal connection becomes a handle;
compressing the upper tool relative to the lower tool such that a raised upper shoulder on the upper tool passes through the top bread layer and bottom bread layer, operatively cutting crusts from the top and bottom bread layers, while a cut edge of the top bread layer is sealed together with a cut edge of the bottom bread layer forming a crustless sandwich with a sealed edge;
pivotally disengaging the upper tool from the lower tool; and
removing a crustless sandwich with a sealed edge from the sandwich making apparatus.

19. The method for making sandwiches of claim 18, wherein the method further comprises preparing filling material using a filling material cup.

20. The method for making sandwiches of claim 19, wherein preparing filling material includes one of measuring, shaping, cutting, and cooking filling material using the filling material cup.

21. The method for making sandwiches of claim 19, further comprising placing filling material in the filling material cup; microwaving the filling material in a filling material cup; inverting the filling material cup; and positioning the filling material on the bottom bread layer.

22. The method of making sandwiches of claim 18, further comprising adding a mirror marking feature impression on an outer sandwich surface prior to pivotally disengaging the upper tool from the lower tool.

23. The method of making sandwiches of claim 18, further comprising placing a sealing wrap layer below the bottom bread layer and a sealing wrap layer above the top bread layer prior to pivotally engaging and compressing the upper tool relative to the lower tool.

24. The method of making sandwiches of claim 18, further comprising storing the crustless sandwich with a sealed edge following removal from the bladeless sandwich making apparatus.

25. The method of making sandwiches of claim 18, further comprising toasting the crustless sandwich with a sealed edge following removal from the bladeless sandwich making apparatus.

26. The method of claim 18, further comprising heating the crustless sandwich with a sealed edge in one of a toaster, an oven, a microwave, a grill, and a flame.
